(19) United States
(12) Patent Application Publication
(10) Pub. No.: US 2012/0254211 A1
(43) Pub. Date: Oct. 4, 2012

(54) METHOD AND APPARATUS FOR MODE MATCHING

(75) Inventors: Erez BUCHNIK, ZORAN (IL); Jingzhong QIU, Shenzhen (CN)

(73) Assignee: HUAWEI TECHNOLOGIES CO., LTD., Shenzhen (CN)

(21) Appl. No.: 13/436,028

(22) Filed: Mar. 30, 2012

Related U.S. Application Data
(63) Continuation of application No. PCT/CN2011/079865, filed on Sep. 20, 2011.

(30) Foreign Application Priority Data
Apr. 2, 2011 (CN) 201110083536.0

(51) Int. Cl. G06F 17/30

(52) U.S. Cl. 707/758; 707/E17.058

(57) ABSTRACT

The present invention provides a method and an apparatus for mode matching. The method for mode matching includes: reading the mode matching string, where the mode matching string includes at least one logical matching field that is used to match the logical relationship; reading the target character string to be matched, where the target character string to be matched includes logical relationship information; using the logical matching field in the mode matching string to match the logical relationship in the target character string to be matched. The technical solution of the present invention improves the capability for matching the text information that carries the logical relationship information.

### CROSS-REFERENCE TO RELATED APPLICATIONS

This application is a continuation of International Application No. PCT/CN2011/079865, filed on Sep. 20, 2011, which claims priority to Chinese Patent Application No. 201110083536.0, filed with the Chinese Patent Office on Apr. 2, 2011 and entitled “METHOD AND APPARATUS FOR MODE MATCHING”, which is incorporated herein by reference in its entirety.

### FIELD OF THE INVENTION

The invention relates to the communications technology field and relates to a method and an apparatus for mode matching.

### BACKGROUND OF THE INVENTION

At present, broadband services bring carriers opportunities while also challenges. Carriers face a series of new topics such as bandwidth management, content charging, and information security. With the increasing peer-to-peer (P2P, Peer-to-Peer) service traffic, the deep packet inspection (DPI, Deep Packet Inspection) technology is considered as an effective method for multi-service management and control.

The characteristic word-based identification technology of the DPI technology is the most basic and widely applied. Different applications use different protocols and different protocols use different special fingerprints. The fingerprints may be specific ports, character strings, or bit sequence. The characteristic word-based identification technology determines the applications borne over the service traffic based on the fingerprint information in the data packets. According to different detection modes, the characteristic word-based identification technology is classified into fixed-location characteristic word matching, variable-location characteristic word matching, and status characteristic work matching.

The DPI can identify various characteristic words from packets in various formats. The identification is implemented using the mode matching technology, for example, character string matching. That is, the target character string is matched from the packets. The mode matching technology is simple and easy to expand. Therefore, the mode matching plays an important role in the DPI technology. The mode matching supports three matching algorithms:

Single-mode matching: A scanning for the target string can match only a mode string. In single-matching algorithm, to match multiple mode strings, the corresponding number of scanning times must be performed.

Multi-mode matching: A scanning for the target string can match multiple mode strings. Compared with the single-mode matching algorithm, the multi-mode matching algorithm achieves multiple mode string matching in a traversal, which greatly improves the matching efficiency.

Regular expression matching: The regular expression describes a character string matching mode. The regular expression can be used to check whether certain substrings exist in a character string. Compared with the single-mode and multi-mode matching algorithms, the regular expression matching algorithm provides powerful character string retrieval and matching capabilities.

The mode matching is used to retrieve and match the text information. The existing matching mechanism cannot effectively match the text information that carries logical relationship information. For example, protocol A has a character string A1A2A3A4+B1B2B3B4=3010. A1, A2, A3, A4, B1, B2, B3, and B4 are integers from 1 to 9. The character string of protocol A must meet the logical condition A1A2A3A4+B1B2B3B4=3010. For example, when the value of A1A2A3A4 is 1234 and that of B1B2B3B4 is 1776, A1A2A3A4+B1B2B3B4=(1234+1775)=3010. Therefore, the character string meets both the characteristic of protocol A and the logical condition. When the value of A1A2A3A4 is 1235 and that of B1B2B3B4 is 1777, A1A2A3A4+B1B2B3B4=(1235+1777)=3012. Therefore, the character string does not meet the characteristic of protocol A. The existing mode matching mechanism, however, considers that the character string in both situations meets the characteristic of protocol A. The existing mode matching mechanism cannot effectively identify the text information with logical relationship information. The matching may be faulty.

### SUMMARY OF THE INVENTION

The embodiments of the present invention provide a method and an apparatus for mode matching, which improves the capability for matching the text information that carries logical relationship information.

To resolve the preceding technical issues, the invention provides the following technical solutions:

A method for mode matching, including:

reading a mode matching string, where the mode matching string includes at least one logical matching field that is used to match a logical relationship;

reading a target character string to be matched, where the target character string to be matched includes a logical relationship;

performing, by using the logical matching field in the mode matching string, logical matching on the logical relationship in the target character string to be matched.

A method for mode matching, including:

reading the mode matching string: The mode matching string includes at least one logical matching field that is used to match the logical relationship and at least one character matching field that is used to match the character string;

reading the target character string to be matched;

determining whether the character matching field or logical matching field in the mode matching string is currently used to perform matching;

if it is determined that the character matching field in the mode matching string is currently used to perform matching, triggering a corresponding character matching operation that is performed by the character matching filed to perform matching on a character substring at a corresponding position in the target character string to be matched;

if it is determined that the logical matching field in the mode matching string is currently used to perform matching, triggering a logical matching operation that corresponds to the logical matching field to perform matching on the logical relationship in the target character string to be matched.

An apparatus for mode matching, including:

a first reading module, configured to read a mode matching string, where the mode matching string includes at least one logical matching field that is used to match a logical relationship;

a second reading module, configured to read a target character string to be matched;

a logical matching module, configured to perform, by using the logical matching field, matching on the logical relationship in the target character string read by the second reading module.

An apparatus for mode matching, including:

a first reading module, configured to read a mode matching string, where the mode matching string includes at least one logical matching field that is used to match a logical relationship and at least one character matching field that is used to match a character string;

a second reading module, configured to read a target character string to be matched.

a type determining module, configured to determine whether the character matching field or logical matching field in the mode matching string is currently used to perform matching.

a character matching module, configured to: if the type determining module determines that the character matching field in the mode matching string is currently used to perform matching, trigger a character matching operation that corresponds to the character matching field, and perform matching on a character substring at a corresponding position in the target character string to be matched;

a logical matching module, configured to: if the type determining module determines that the logical matching field in the mode matching string is currently used to perform matching, trigger a logical matching operation that corresponds to the logical matching field to perform matching on the logical relationship in the target character string to be matched.

It can be seen from the above that, in the embodiment of the present invention, at least one logical matching field that is used to match the logical matching relationship is introduced in the mode matching string, and the target character string is matched by using the mode matching string that includes the logical matching field and the matching is performed on the logical relationship included in the target character string by using the logical matching field in the mode matching string. Such mechanism enables the mode matching to support accurate retrieval and matching of text information that includes logical relationship information, which improves the capability of matching the text information that carries logical relationship information and extends applications of mode matching.

### BRIEF DESCRIPTION OF THE DRAWINGS

To clearly describe the embodiments or technical solutions of the present invention, figures are used to describe to simply introduce the embodiments or technical solutions. Obviously, the figures in the description are only a part of embodiments of the present invention. For those skilled in the art, without paying any creative work, those skilled can obtain other figures based on the figures provided in the present invention.

FIG. 1 shows a flowchart of a mode matching method provided in the present invention.

FIG. 2 shows a flowchart of another mode matching method provided in the present invention.

FIG. 3 shows a flowchart of another mode matching method provided in the present invention.

FIG. 4-a shows a flowchart of a mode matching string provided in the present invention.

FIG. 4-b shows a flowchart of another mode matching string provided in the present invention.

FIG. 4-c shows a flowchart of another mode matching string provided in the present invention.

FIG. 5 shows a structure diagram of another mode matching apparatus provided in the present invention.

FIG. 6 shows a structure diagram of a mode matching apparatus provided in the present invention.

FIG. 7 shows a structure diagram of another mode matching apparatus provided in the present invention.

FIG. 8-a shows a structure diagram of another mode matching apparatus provided in the present invention.

FIG. 8-b shows a structure diagram of another mode matching apparatus provided in the present invention.

### DETAILED DESCRIPTION

The present invention provides a method and an apparatus for mode matching.

The embodiments of the present invention are used to describe the method and apparatus for mode matching.

To help those skilled in the art better understand the technical solution of the present invention, figures are used in the embodiments of the present invention to clearly and comprehensively describe the technical solutions. Obviously, the embodiments in the description are only a part of embodiments of the present invention. Without any creative work and base on the embodiments provided in the present invention, those who are ordinarily skilled in the related art could obtain any other embodiments which are not considered out of the scope of the present invention.

An embodiment of the present invention includes: reading a mode matching string, where the mode matching string includes at least one logical matching field that is used to match a logical relationship; reading a target character string to be matched, where the target character string to be matched includes a logical relationship; and performing, by using the logical matching field in the mode matching string, logical matching on the logical relationship in the target character string to be matched.

Referring to FIG. 1, the steps are as follows:

110. Read a mode matching string. The mode matching string includes at least one logical matching field that is used to match a logical relationship.

In practice, the mode matching string that is read may include at least one logical matching field that is used to match a logical relationship. The logical matching field may be used to match the logical relationship, for example, through a logical operation or other methods. Certainly, the mode matching string may further include at least one character matching field that is used to match a character string. The character matching field may be a regular expression or a character string (including one or more characters). In addition, if the character matching field includes a regular expression, the regular expression may be a Perl compatible regular expression (PCRE), portable operating system interface of Unix (POSIX) regular expression, or other types of regular expressions.

Further, to improve the matching speed, the mode matching string that is read can be pre-compiled, that is, before being matched, the mode matching string is compiled to be corresponding binary code. Certainly, the compilation can also be implemented during the matching.

120. Read a target character string to be matched.

The target character string may be read from received data packets (such as messages). The target character string to be matched may include a logical relationship. The logical relationship may be, for example, a specific logical relationship that exists between and is satisfied by character substrings located at two positions in the target character string to be matched, or may be other logical relationship, which is not restricted here.

130. Perform, by using the logical matching field in the mode matching string that is read, matching on the logical relationship in the target character string to be matched.

In an application scenario, if the mode matching string that is read includes multiple logical matching fields, the target character string is matched by sequentially using each of the logical matching fields according to the sequence of the logical matching fields in the mode matching string; or the target character string is concurrently matched by using each of the logical matching fields in the mode matching string; or the preceding two ways are combined, that is, matching is performed sequentially by using multiple logical matching fields, and matching is performed concurrently by using multiple logical matching fields. For example, the mode matching string includes 5 logical matching fields. In such case, the first 1 logical matching field is used to match the target character string first, then the middle 3 logical matching fields are used to match the target character string concurrently, and at last, the last 1 logical matching field is used to match the target character string. Other cases may be deduced based on this case.

In actual applications, the logical operation described in the logical matching field can include one or more of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right. When the logical matching field in the mode matching string is used to perform matching, the matching may be performed on the logical matching relationship included in the target character string to be matched by performing a combination or one of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right. Certainly, the logical matching field may also correspond to other types of logical operations, which are not described here.

The logical relationship matched by the logical matching field may include a specific logical relationship which a certain character substring or multiple character substrings in the target character string satisfy.

It should be noted that the code of the logical matching field in the embodiment of the present invention complies with the syntax rules of various program languages such as the extensible markup language (XML, Extensible Markup Language) or self-defined simple script languages.

The logical operation that corresponds to the logical matching field can be implemented by invoking a function. For example, when the logical matching field in the mode matching string is used to perform matching, a corresponding function is invoked, and by performing a logical operation described by the function, the matching on the logical relationship included in the target character string is performed, and a matching result is returned. In addition, the logical operation can be described in the logical matching field, so that the logical operation may be directly implemented through the logical matching field without invoking a corresponding function.

In an application scenario, if the mode matching string includes at least one logical matching field used to match the logical relationship (by using a logical operation or other modes) and at least one character matching field used to match a character string, the target character string is matched sequentially by using the logical matching fields and the character matching fields according to the sequence of the logical matching fields and the character matching fields in the mode matching string; or the target character string is concurrently matched by using the logical matching fields and the character matching fields in the mode matching string; otherwise, a combination of the foregoing two matching ways is allowable. Other cases may be deduced based on this case.

The technical solution of the present invention supports the bandwidth management, content charging, and information security for the DPI devices, security protection devices, or other related devices.

It can be seen from the above that, in the embodiment of the present invention, at least one logical matching field that is used to match the logical matching relationship is introduced in the mode matching string, and the target character string is matched by using the mode matching string that includes the logical matching field, and the matching is performed on the logical relationship included in the target character string by using the logical matching field. Such mechanism enables the mode matching to support accurate retrieval and matching of text information that includes logical relationship information, which improves the capability of matching the text information that carries logical relationship information and extends applications of mode matching.

Another embodiment of the present invention may include: reading a mode matching string, where the mode matching string includes at least one logical matching field that is used to match the logical relationship, and at least one character matching field that is used to match a character string; reading a target character string to be matched, where the target character string to be matched includes a logical relationship; determining whether the character matching field or logical matching field in the mode matching string is currently used to perform matching; if it is determined that the character matching field in the mode matching string is currently used to perform matching, triggering a character matching operation that corresponds to the character matching field to perform matching on a character substring at a corresponding position in the target character string to be matched; if it is determined that the logical matching field in the mode matching string is currently used to perform matching, triggering a logical matching operation that corresponds to the logical matching field to perform matching on the logical relationship in the target character string to be matched.

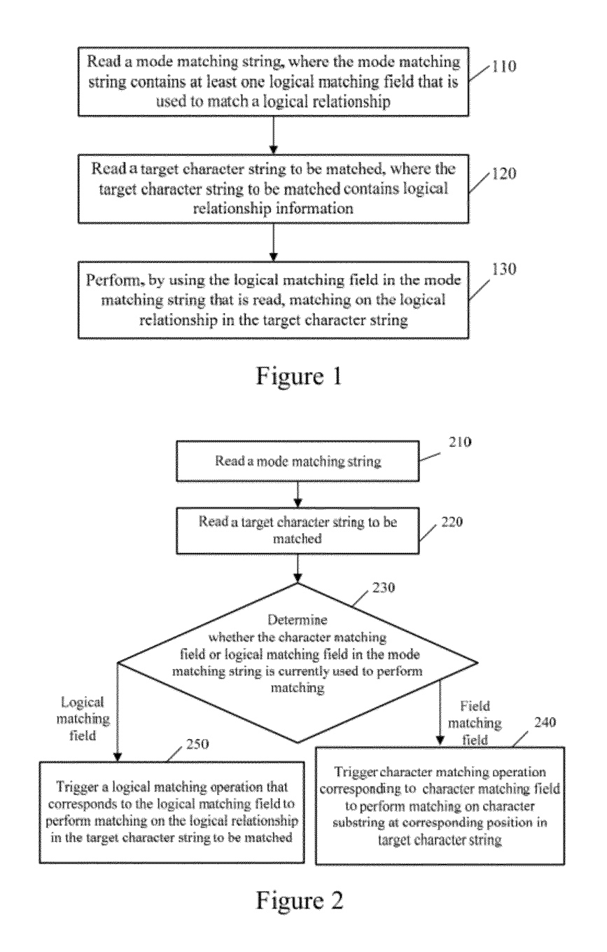

Referring to FIG. 2, the steps are as follows:

210. Read a mode matching string. The mode matching string includes at least one logical matching field that is used to match a logical relationship and at least one character matching field that is used to match a character string.

The logical matching field in the mode matching string may be used to match the logical relationship, for example, through a logical operation or other methods. The character matching field may be a regular expression or a character string (including one or more characters). In addition, if the character matching field includes a regular expression, the regular expression may be PCRE, POSIX, or other types of regular expressions.

Further, to improve the matching speed, the mode matching string that is read can be pre-compiled, that is, before being matched, the mode matching string is compiled to be corresponding binary code. Certainly, the compilation can also be implemented during the matching.

220. Read the target character string to be matched.

The target character string may be read from received data packets (such as messages). The target character string to be matched may include a logical relationship. The logical relationship may be, for example, a specific logical relationship that exists between and is satisfied by character substrings at two positions in the target character string to be matched or may be other logical relationship, which is not restricted here.

230. Determine whether the character matching field or logical matching field in the mode matching string is currently used to perform matching.

In actual applications, different types of matching fields may, for example, be set to different separators or formats. Therefore, it may be determined that each matching field in the mode matching string is a character matching field or a logical matching field according to the separators or formats.

If it is determined that the character matching field in the mode matching string is currently used to perform matching, perform step 240; if it is determined that the logical matching field in the mode matching string is currently used to perform matching, perform step 250.

240. Trigger a character matching operation that corresponds to the character matching field to perform matching on a character substring at a corresponding position in the target character string to be matched.

250. Trigger a logical matching operation that corresponds to the logical matching field to perform matching on the logical relationship in the target character string to be matched.

In actual applications, the logical operation described in the logical matching field may include one or more of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right. When it is determined that a matching unit that is currently used to perform matching in the mode matching string is a logical matching fields, the matching may be performed on the logical matching relationship included in the target character string to be matched by performing one or a combination of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right can be executed to match the logical relationship in the target character string. The logical matching field may also correspond to other types of logical operations, which are not described here.

The logical relationship matched by the logical matching field may include a certain logical relationship which a certain character substring or multiple character substrings in the target character string need to satisfy.

It should be noted that the code of the logical matching field in the embodiment of the present invention complies with the syntax rules of various program languages such as the extensible markup language XML or self-defined simple script languages.

The logical operation that corresponds to the logical matching field can be implemented by invoking a function. For example, when the logical matching field in the mode matching string is used to perform matching, a function that corresponds to the logical matching field is invoked, and by performing a logical operation described by the function, the matching on a logical relationship included by the target character string is performed, and a matching result is returned. In addition, the logical operation may be directly expressed in the logical matching field, so that the logical operation can be directly implemented through the logical matching field without invoking a corresponding function.

The technical solution of the present invention supports the bandwidth management, content charging, and information security for the DPI devices, security protection devices, or other related devices.

It can be seen from the above that, in the embodiment of the present invention, at least one logical matching field that is used to match the logical matching relationship is introduced in the mode matching string that includes the character matching field, and the target character string is matched by using the mode matching string that includes the logical matching field, in which the matching is performed on the character substring at a corresponding position in the target character string by using the character matching field, and the matching is performed on the logical relationship included in the target character string by using the logical matching field. Such mechanism enables the mode matching to support accurate retrieval and matching of text information that includes logical relationship information, which improves the capability of matching the text information that carries logical relationship information and extends applications of mode matching.

To help better understand the technical solution of the present invention, the following takes the process of matching a target character string by using several “logical matching fields” extended in the mode matching string that includes a PCRF as an example to describe the matching process.

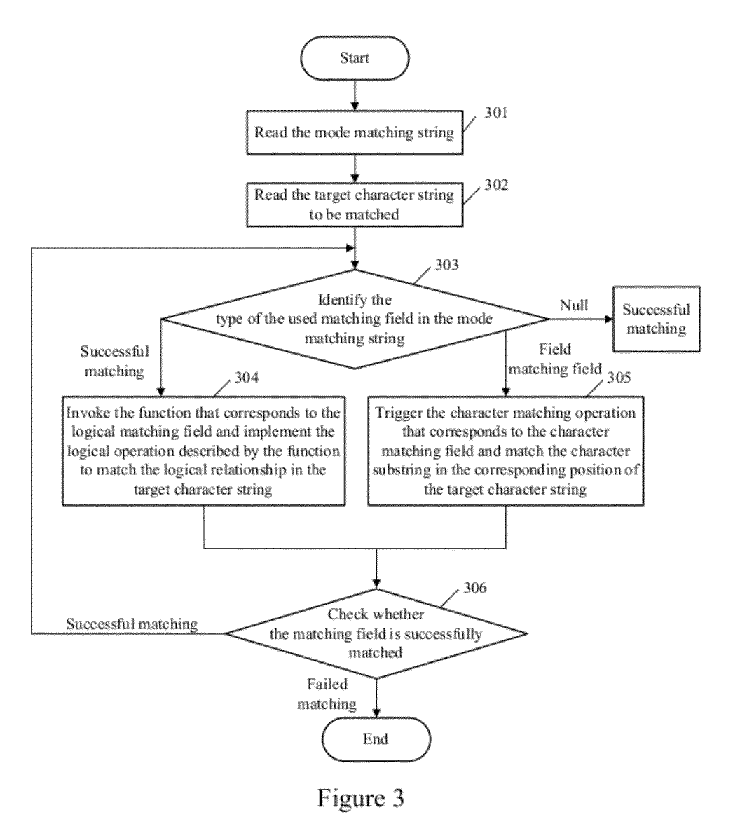

Referring to FIG. 3, the steps are as follows:

301. Read a mode matching string.

The mode matching string includes multiple matching fields, specifically including at least one logical matching field that is used to match a logical relationship by using a logical operation or other modes, and at least one PCRE, or at least one character string (including one or more characters). The character string or PCRE in the mode matching string may be considered as a type of character matching field.

Further, to improve the matching speed, the mode matching string may be pre-compiled.

302. Read a target character string to be matched.

The target character string may be read from received data packets (such as messages). The target character string to be matched may include a logical relationship. The logical relationship may be a specific logical relationship that exists between and is satisfied by character substrings at two positions in the target character string to be matched, or may be other logical relationship which is not restricted here.

303. Determine whether the character matching field or logical matching field in the mode matching string is currently used to perform matching.

If it is determined that the logical matching field in the mode matching string is currently used to perform matching, perform step 304.

If it is determined that the character matching field (PCRE or character string) in the mode matching string is currently used to perform matching, perform step 305.

If it is determined that there are no matching fields in the mode matching string (that is, all matching fields in the mode matching string are used to perform matching), it indicates that the target character string is successfully matched. In this case, the information about successful matching of the target character string is returned.

Specific symbols may be set in order to specify an area of a logical matching field. For example, an area of a logical matching field may begin at (?F and end at “)”. The area between “(?F” and “)” is an area of a logical matching field. Certainly, other specific symbols may be used to specify an area of a logical matching field, which are not restricted here.

In actual applications, the logical operation described in the logical matching field may include one or more of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right. Certainly, one or more other operations may be included.

In the embodiment, that the logical operation that corresponds to the logical matching field may be implemented by invoking a function and may be taken as an example for description. The function that corresponds to the logical matching field describes a corresponding logical operation.

304; Invoke the function that corresponds to the logical matching field, perform matching on the logical relationship included in the target character string by performing the logical operation described in the function, and return a matching result; perform step 306.

For example, the following may be defined: when the result of a logical operation is 0, it indicates that the matching fails, otherwise, it indicates that the matching succeeds.

The logical relationship matched by the logical matching field may include a certain logical relationship which a certain character substring or multiple character substrings in the target character string need to satisfy.

305. Trigger the character matching operation that corresponds to the character matching field; match the character substring at a corresponding position in the target character string; return a matching result; perform step 306.

Various existing matching algorithms may be selected to match a corresponding character substring in the target character string by using the character matching field.

306. Check whether the matching succeeds.

If the matching succeeds, perform step 303.

Otherwise, the target character string fails to be matched and the matching process ends.

It is understandable that, step 303 to step 306 may be implemented repeatedly to match the target character string by using multiple matching fields included in the mode matching string.

It should be noted that the code of the logical matching field in the embodiment of the present invention complies with the syntax rules of various program languages such as the XML or self-defined simple script languages.

It is understandable that, the preceding process is described by taking the following as an example: the target character string is matched sequentially according to the sequence of the logical matching fields and the character matching fields in the mode matching string. Certainly, the target character string may be matched concurrently by using the logical matching fields and the character matching fields in the mode matching string, or the preceding two ways are combined, which are not described again here.

To facilitate understanding, figures are used to compare the common mode matching string in the prior art with the mode matching string provided in the present invention.

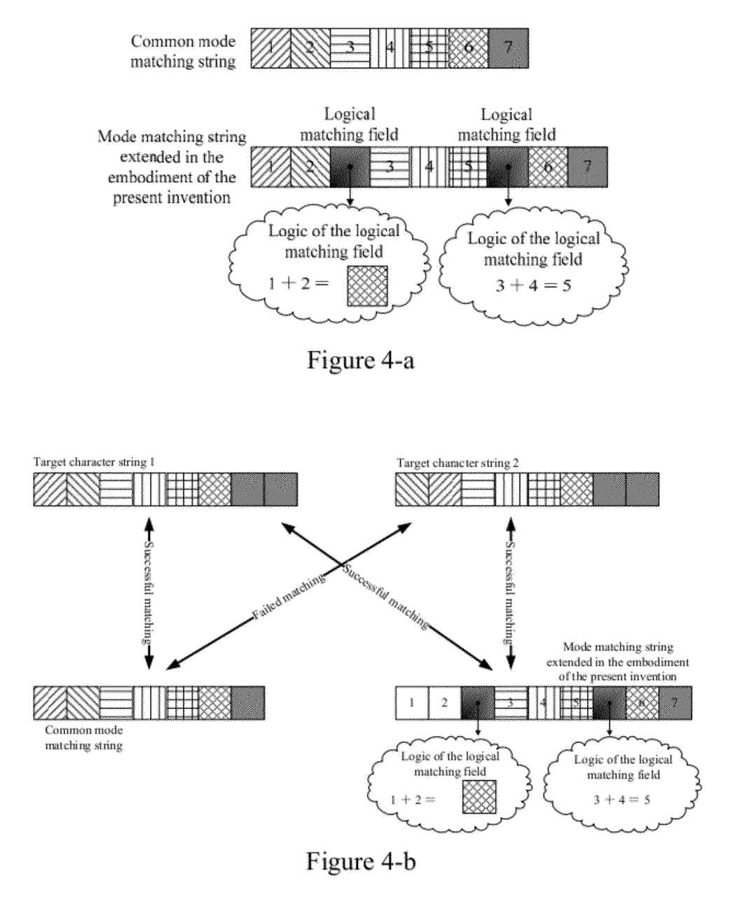

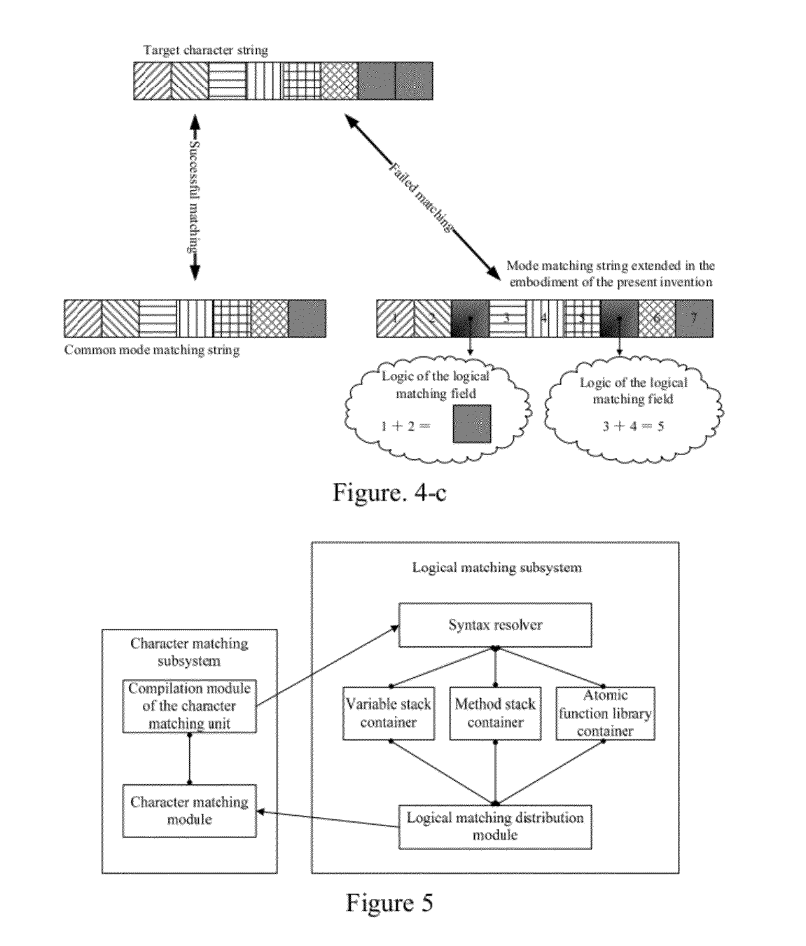

As shown in FIG. 4-a, two logical matching fields are added to the common mode matching string. Two logical matching fields are inserted between character matching fields. The two logical matching fields may be used to implement the character matching or relationship matching between character substrings.

As shown in FIG. 4-b, character matching fields 1-7 in the common mode matching string in the prior art form a character string (including one or more characters). When the common mode matching string successfully matches target character string 1 but fails to match target character string 2 because character matching fields 1 and 2 are different from a corresponding part in target character string 2. The character strings at position 1 and position 2 of each of the target character string 1 and target character string 2 must comply with a specific logical relationship. The character strings at position 3 and position 4 of each of the target character string 1 and target character string 2 must also comply with a specific logical relationship. As shown in FIG. 4-b, character matching fields 1 and 2 of the logical matching fields are added to the mode matching string as regular expressions (they are used to indicate any character string). The logical matching field inserted behind character matching field 2 of the mode matching string describes a logical relationship with which the character strings at position 1 and position 2 of the target character string must comply. The logical matching field inserted behind character matching field 4 of the mode matching string describes a logical relationship with which the character strings in position 3 and position 4 of the target character string must comply. When the mode matching string that is added the logical matching fields is used to match target character strings 1 and 2, character strings at position 1 and position 2 comply with the specific logical relationship and character strings at position 3 and position 4 also comply with the specific logical relationship. Therefore, the matching succeeds. If any or both logical relationships are not met, the matching fails.

As shown in FIG. 4-c, character matching fields 1-7 in the common mode matching string form a character string (including one or more characters). The common mode matching string successfully matches the target character string (the character strings at position 1 and position 2 must comply with a specific logical relationship, and the character strings at position 3 and position 4 must also comply with the specific logical relationship) because the common mode matching string cannot match the logical relationship between substrings in the target character string. As shown in FIG. 4-c, the logical character string that describes the relationship between character substrings at position 1 and position 2 of the target character string is inserted behind character matching field 2 and the logical character string that describes the relationship between character substrings at position 3 and position 4 of the target character string is inserted behind character matching field 4. When the extended mode matching string is used to match the target character string, the matching fails if the character substrings at position 1 and position 2 or the character substrings at position 3 and position 4 do not comply with a corresponding logical relationship. If both logical relationships are met, the matching succeeds.

It may be seen from above that, the mode matching string with extended logical matching fields that is used to match target character strings has better readiness and a wider application scope.

To facilitate understanding, the following takes an application example to describe the matching process.

Syntax for activating a logical matching field is defined by using examples. Other syntax may also be defined to activate logical matching fields.

For example, a logical matching field area begins at (?F and ends at “)”. The area between “(?F” and “)” is the logical matching field area.

For example, in the PCRE “̂AABCD(?F somefunc( . . . ))”, “̂AABCD” indicates a PCRE matching unit, “(?F” and “)” specify the area “somefunc( . . . )”, which is a logical matching field area.

The syntax and semantics of the logical matching fields in the example are as follows:

Control unit=“(” “?” “F” method name “(”[parameter[*SP “,” *SP parameter]] “)” “)”

Method name=(ALPHA/“_”)*(ALPHA/DIGIT/“_”)

Parameter=Constant/integer variable/PCRE capture/expression

Constant=1*DIGIT

Integer variable=“<” (ALPHA/“_”)*(ALPHA/DIGIT/“_”) “>”

PCRE capture=“{” capture index number “}”

Capture index number=1*DIGIT

Expression=1*((unary operator operation unit)/(operation unit binary operator operation unit))

Unary operator=“!”/“˜”

Binary operator=“+”/“˜”/“*”/“/”/“%”/“&”/“|”/“̂”/“<<”/“>>”/“<”/“<=”/“>=”/“>”/“==”/“!=”/“&&”/“∥”/“(”/“)”

Operation unit=Constant/Integer variable/PCRE capture

In the PCRE, the target character string matched between “(” and with “)” (except the logical matching fields) is the captured character string.

Assume that the target character string is “ABCDEFG”. If the PCRE matching unit is “̂( . . . )DE( . . . )”, capture character string 1 is the part in the brackets before “DE” and matches “ABC” in the target character string. Therefore, capture character string 1 (may be represented by “{1}”) indicates “ABC”. Capture character string 2 is the part in the brackets after “DE” and matches “FG” in the target character string. Therefore, capture character string 2 (may be represented by “{2}”) indicates “FG”. Other cases may be deduced based on this case.

The following table lists the methods supported by the logical matching fields in the embodiment of the present invention.

| Method | Param- | | Param- | |
|---|---|---|---|---|
| Name | eter 1 | Parameter 2 | eter 3 | Function |
| assert | Expres- | None | None | To calculate a value of the |
| | sion | | | expression of parameter 1. |
| | | | | If the value of the expression |
| | | | | of parameter 1 is 0, that the |
| | | | | matching fails is returned in |
| | | | | this method. Otherwise, that |
| | | | | the matching succeeds is |
| | | | | returned. |
| set | Integer | Expression | None | To calculate a value of the |
| | variable | | | expression of parameter 2 and |
| | | | | assign the value of the |
| | | | | expression to an integer |
| | | | | variable of parameter 1. |
| | | | | If the expression of parameter |
| | | | | 2 is a character string, the |
| | | | | character string is converted |
| | | | | into an integer value and the |
| | | | | integer value is assigned to an |
| | | | | integer variable of parameter |
| | | | | 1, and that the matching |
| | | | | succeeds is always returned |
| | | | | in this method. |
| . . . | . . . | . . . | . . . | . . . |

According to the definition of the syntax of logical matching fields, “AABCD(?F assert (1, 2))” does not comply with the syntax rule while “̂AABCD(?F assert(1+2=3))” complies with the syntax rule of the mode matching string.

Assume that the feature character string of protocol A is “A1A2A3A4+B1B2B3B4=3010”, A1, A2, A3, A4, B1, B2, B3, and B4 are integers from 1 to 9. The feature character string must comply with the logical condition, that is, “A1A2A3A4+B1B2B3B4=3010”.

Based on the preceding syntax definition, the protocol A-based mode matching string (with extended logical matching fields) is as follows, but is not limited to the following: ̂([1-9][1-9][1-9][1-9]((?F set(<var1>,{1}))\+([1-9][1-9][1-9][1-9])(?F set(<var2>,{2}))=3010(?F assert(<var1>+<var2>=3010))

In the preceding mode matching string, three logical matching fields are added to the mode matching string:

(?F set(<var1>, {1}))

(?F set(<var2>, {2}))

(?F assert(<var1>+<var2>=3010))

To facilitate understanding, the following takes the process of matching the target character string “1234+1776=3010” as an example to describe the process of matching the mode matching string with extended logical matching fields.

The matching on the first logical matching field “(?F set(<var1>,{1}))” is performed after “1234” is matched. After “1234” is matched, the matching of “(?F set(<var1>,{1}))” is activated. The library function “set” is invoked and capture 1, that is, “1234” is converted into an integer. The integer is assigned to the variable “<var1>”. “(?F set(<var1>,{1}))” is successfully matched and the subsequent matching continues.

Similarly, the matching on the second logical matching field “(?F set(<var2>,{2}))” is performed after the character string “1776” is matched. After “1776” is matched, the matching of “(?F set(<var2>,{2}))” is activated. The library function “set” is invoked and capture 2, that is, “1776” is converted into an integer. The integer is assigned to the variable “<var2>”.“(?F set(<var2>,{2}))” is successfully matched and the subsequent matching continues.

The matching on the third logical matching field “(?F assert(<var1>+<var2>=3010))” is performed after the character string “3010” is matched. After “3010” is matched, the matching of “(?F assert(<var1>+<var2>=3010))” is activated. The library function “assert” is invoked to calculate a value of the expression “<var1>+<var2>==3010”. The value of the expression is 1. Therefore, the matching of “(?F assert(<var1>+<var2>==3010))” succeeds.

The target character string “1234+1776=3010” is successfully matched and it complies with protocol A.

To facilitate understanding, the following describes a module implementation structure of the mode matching apparatus by using an example to describe the matching process. The mode matching apparatus may be divided into a character matching subsystem and a logical matching subsystem. The character matching subsystem reads a mode matching string and a target character string to be matched, and performs a character matching operation that corresponds to the character matching field.

As shown in FIG. 5, a logical matching subsystem is added to a mode matching apparatus for logical matching. The logical matching subsystem includes: a syntax resolver, a variable stack container, a method stack container, an atomic function library container, and a logical matching distribution module.

The syntax resolver is configured to resolve syntax of a logical matching field.

The variable stack container is configured to store a variable introduced during a process of performing a logical operation that corresponds to one or more logical matching fields in the mode matching string.

The method stack container is configured to store an entry address of a function that corresponds to each logical matching field that is in the mode matching string and resolved by the syntax resolver, where the entry address of the function may be obtained based on the name of the function that corresponds to the logical matching field resolved by the syntax resolver and a mapping table related to the name of the function.

A mode matching string may include multiple logical matching fields. When the entry address of the function that corresponds to each logical matching field is stored in the method stack container during the compilation, the storage index can be the position of the logical matching field in the mode matching string.

The atomic function library container is configured to store a function invoking group (such as “assert” and “set”), including the function of the entry address stored in the method stack container.

The logical matching distribution module is configured to invoke, during a process of performing logical matching that corresponds to a certain logical matching field in the mode matching string, a corresponding function in the function invoking group stored by the atomic function library container to perform matching on the logical relationship in the target character string to be matched read by the second reading module according to the entry address of the function that corresponds to the logical matching field stored in the method stack container.

The logical matching distribution module completes the atomic function invoking and matching process.

The mode matching can be implemented based on the structure of the mode matching apparatus in FIG. 5.

The technical solution of the present invention supports the bandwidth management, content charging, and information security for DPI devices, security protection devices, or other related devices.

It can be seen from the above that, in the embodiment of the present invention, at least one logical matching field that is used to match the logical matching relationship by performing a logical operation is introduced in the mode matching string, and the target character string is matched by using the mode matching string that includes the logical matching field, and when the logical matching field in the mode matching string is used to perform matching, the matching is performed on the logical relationship included in the target character string by performing a logical operation that corresponds to the logical matching field. Such mechanism enables the mode matching to support accurate retrieval and matching of text information that includes logical relationship information, which improves the capability of matching the text information that carries logical relationship information and extends applications of mode matching.

Further, the logical matching fields may be used to perform various logical matching and perform the retrieval and matching of variable feature character strings. If a mode matching string of a new protocol is added to a DPI device, the matching of a feature character string of the new protocol may be easily completed based on the previous mode matching process, and the seamless upgrade on function and service identifying of the DPI device is supported.

The present invention further provides a related apparatus to implement the technical solution.

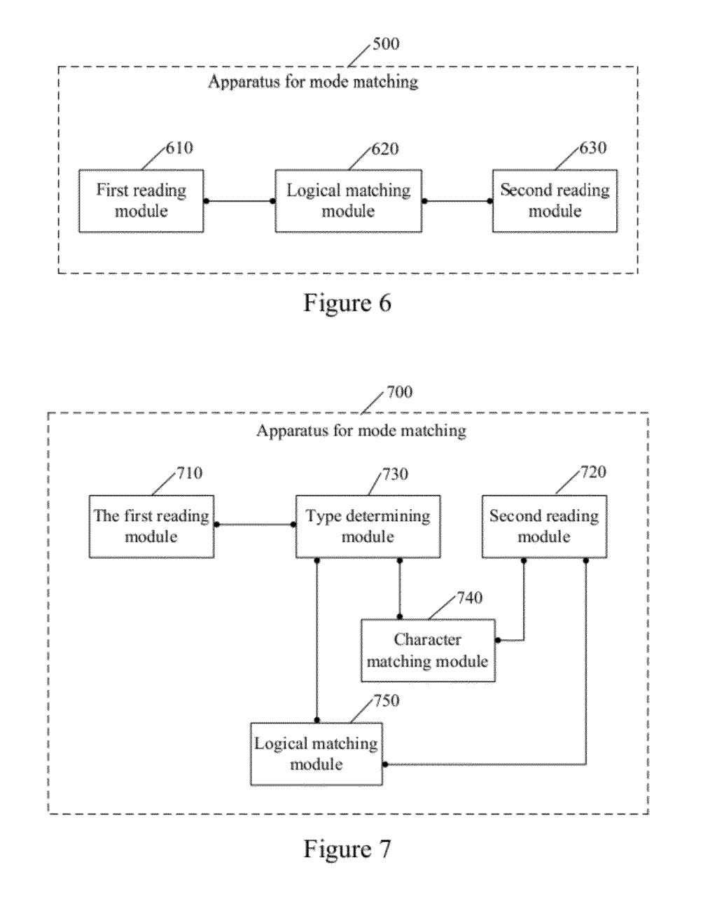

As shown in FIG. 6, a mode matching apparatus 600 is provided. The mode matching apparatus includes a first reading module 610, a second reading module 620, and a logical matching module 630.

The first reading module 610 is configured to read a mode matching string. The mode matching string includes at least one logical matching field that is used to match a logical relationship.

In actual applications, the mode matching string that is read by the first reading module 610 may include at least one logical matching field that is used to match a logical relationship through a logical operation or other methods. Certainly, the mode matching string may further include at least one character matching field that is used to match a character string. The character matching field may be a regular expression or a character string (including one or more characters).

If the mode matching string read by the first reading module 610 includes a character matching field, and one or more character matching fields include a regular expression, the regular expression may be a PERL compatible regular expression (PCRE), a portable operating system interface of Unix (POSIX), or other types of regular expressions.

The second reading module 620 is configured to read a target character string to be matched.

The second reading module 620 reads the target character string from received data packets (such as messages). The target character string to be matched may include a logical relationship. The logical relationship may be, for example, a specific logical relationship that exists between and is satisfied by character substrings at two positions in the target character string to be matched or may be other logical relationship, which is not restricted here.

The logical matching module 630 is configured to perform, by using the logical matching field read by the first reading module 610, matching on the logical relationship in the target character string read by the second read module 620.

In an application scenario, the logical matching module 630 may perform, by performing a logical operation that corresponds to the logical matching field, matching on the logical relationship in the target character string read by the second reading module 620.

In actual applications, the logical operation described in the logical matching field can include one or more of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right. When a certain logical matching field in the mode matching string is used to perform matching, the matching may be performed on the logical matching relationship included in the target character string to be matched by performing one or a combination of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right.

The logical relationship matched by the logical matching field may include a certain logical relationship which a certain character substring or multiple character substrings in the target character string need to satisfy.

In an application, if the mode matching string read by the first reading module 610 includes multiple logical matching fields, the logical matching module 630 may match the target character string by sequentially using each of the logical matching fields according to the sequence of the logical matching fields in the mode matching string, or match the target character string concurrently by using each of the logical matching fields in the mode matching string. Or, the preceding two ways are combined, that is, matching is performed sequentially by using multiple logical matching fields, and matching is performed concurrently by using multiple logical matching fields. For example, the mode matching string includes 6 logical matching fields. In such case, the first 1 logical matching field is used to match the target character string first, then the middle 3 logical matching fields are used to match the target character string concurrently, and at last, the last 1 logical matching field is used to match the target character string. Other cases may be deduced based on this case.

In an application, the mode matching string read by the first reading module 610 may further include at least one character matching field that is used to match the target character string. In actual applications, different types of matching fields may, for example, be set to different separators or formats. Therefore, it may be determined that each matching field in the mode matching string is a character matching field or a logical matching field according to the separators or formats. Specific symbols may be set in order to specify an area of a logical matching field. For example, an area of a logical matching field may begin at (?F and end at “)”. The area between “(?F” and “)” is an area of a logical matching field. Certainly, other specific symbols may be used to specify an area of a logical matching field, which are not restricted here.

The mode matching apparatus 600 may further include a character matching module (not shown in FIG. 6).

The character matching module is configured to perform, by using the character matching field in the mode matching string, character matching on the target character string to be matched.

For example, the target character string read by the second reading module 620 may be matched by the logical matching field and character matching field according to the sequence of the logical matching fields and character matching fields in the mode matching string read by the first reading module 610; or the target character string read by the second reading module 620 may be concurrently matched by the logical matching fields and the character matching fields in the mode matching string read by the first reading module 610. Or, a combination of the foregoing two matching ways is allowable.

In an application scenario, the logical matching module 630 includes a syntax resolver, a method stack container, an atomic function library container, and a logical matching distribution module (not shown in FIG. 6).

The syntax resolver is configured to resolve syntax of the logical matching field in the mode matching string read by the first reading module 610.

The method stack container is configured to store an entry address of a function that corresponds to each logical matching field that is in the mode matching string and resolved by the syntax resolver.

The atomic function library container is configured to store a function invoking group that includes the function (that is, the function that corresponds to each logical matching field in the mode matching string).

The logical matching distribution module is configured to invoke, during a process of performing logical matching that corresponds to the logical matching field in the mode matching string, a corresponding function in the function invoking group stored by the atomic function library container to perform matching on the logical relationship in the target character string to be matched read by the second reading module 620 according to the entry address of the function that corresponds to the logical matching field stored in the method stack container.

In an application scenario, a logical matching module 630 further includes:

a variable stack container, configured to store a variable introduced during a process of performing a logical operation that corresponds to the logical matching field in the mode matching string read by the first reading module.

Further, the mode matching apparatus 600 may further include a pre-compilation module, configured to pre-compile the mode matching string read by the first reading module 610.

It should be noted that the code of the logical matching field in the embodiment of the present invention complies with the syntax rules of various program languages such as the XML or self-defined simple script languages.

It may be understandable that, the mode matching apparatus 600 is configured to implement all the technical solutions of the present invention. For details about the functions of each function module, refer to corresponding embodiments, which are not described here.

It may be understandable that, the mode matching apparatus 600 in the embodiment may be set on the DPI devices, security protection devices, or other related devices, so as to support functions of the bandwidth management, content charging, and information security.

It can be seen from the above that, in the embodiment of the present invention, the mode matching apparatus 600 introduces, in the mode matching string, at least one logical matching field that is used to match the logical matching relationship by performing a logical operation, and the mode matching apparatus 600 matches the target character string by using the mode matching string that includes the logical matching field, and when the logical matching field in the mode matching string is used to perform matching, the matching is performed on the logical relationship included in the target character string by performing a logical operation that corresponds to the logical matching field. Such mechanism enables the mode matching to support accurate retrieval and matching of text information that includes logical relationship information, which improves the capability of matching the text information that carries logical relationship information and extends applications of mode matching.

As shown in FIG. 7, a mode matching apparatus 700 is provided. The mode matching apparatus includes a first reading module 710, a second reading module 720, type determining module 730, a character matching module 740, and a logical matching module 750.

The first reading module 710 is configured to read a mode matching string, where the mode matching string includes at least one logical matching field that is used to match a logical relationship and at least one character matching field that is used to match a character string.

In actual applications, the mode matching string that is read by the first reading module 710 may include at least one logical matching field that is used to match a logical relationship through a logical operation or other methods. Certainly, the mode matching string may further include at least one character matching field that is used to match a character string. The character matching field may be a regular expression or a character string (including one or more characters).

If the mode matching string read by the first reading module 710 includes a character matching field, and one or more character matching fields include a regular expression, the regular expression may be a PERL compatible regular expression (PCRE), a portable operating system interface of Unix (POSIX), or other types of regular expressions.

The second reading module 720 is configured to read a target character string to be matched.

The second reading module 720 reads the target character string from received data packets (such as messages). The target character string to be matched may include a logical relationship. The logical relationship may be a specific logical relationship that exists between and is satisfied by character substrings at two positions in the target character string to be matched or may be other logical relationship, which is not restricted here.

The type determining module 730 is configured to determine whether the character matching field or logical matching field in the mode matching string read by the first reading module 710 is currently used to perform matching.

In actual applications, different types of matching fields may, for example, be set to different separators or formats. Therefore, the type determining module 730 may determine that each matching field in the mode matching string is a character matching field or a logical matching field according to the separators or formats. Specific symbols may be set in order to specify an area of a logical matching field. For example, an area of a logical matching field may begin at (?F and end at “)”. The area between “(?F” and “)” is an area of a logical matching field. Certainly, other specific symbols may be used to specify an area of a logical matching field, which are not restricted here.

The character matching module 740 is configured to: if type determining module 730 determines that the character matching field in the mode matching string is currently used to perform matching, trigger a character matching operation that corresponds to the character matching field to perform matching on a character substring at a corresponding position in the target character string to be matched.

The logical matching module 750 is configured to: if type determining module 750 determines that the logical matching field in the mode matching string is currently used to perform matching, trigger a logical matching operation that corresponds to the logical matching field to perform matching on the logical relationship in the target character string to be matched.

The logical relationship matched by the logical matching field may include a certain logical relationship which a certain character substring or multiple character substrings in the target character string need to satisfy.

In an application scenarios, the logical matching module 750 is specifically configured to: if the type determining module 730 determines that the logical matching field in the mode matching string is currently used to perform matching, perform, by triggering a logical matching operation that corresponds to the logical matching field, matching on the logical relationship in the target character string to be matched.

In actual applications, the logical operation described in the logical matching field may include one or more of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right. When a certain logical matching field in the mode matching string is used to perform matching, the logical matching module 750 may perform the matching on the logical matching relationship included in the target character string to be matched by performing one or a combination of the following operations: adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right.

In an application scenario, the logical matching module 750 includes a syntax resolver, a method stack container, an atomic function library container, and a logical matching distribution module (not shown in FIG. 7).

The syntax resolver is configured to resolve syntax of a logical matching unit in the mode matching string read by the first reading module 710.

The method stack container is configured to store an entry address of a function that corresponds to each logical matching unit that is in the mode matching string and resolved by the syntax resolver.

The atomic function library container is configured to store a function invoking group that includes the function (that is, the function that corresponds to each logical matching field in the mode matching string).

The logical matching distribution module is configured to invoke, during a process of performing logical matching that corresponds to the logical matching field in the mode matching string, a corresponding function in the function invoking group stored by the atomic function library container to perform matching on the logical relationship in the target character string to be matched read by the second reading module 720 according to the entry address of the function that corresponds to the logical matching field stored in the method stack container.

In an application scenario, the logical matching module 750 further includes:

a variable stack container, configured to store a variable introduced during a process of performing a logical operation that corresponds to the logical matching field in the mode matching string read by the first reading module 710.

It may be understandable that, the mode matching apparatus 700 is configured to implement all the technical solutions of the present invention. For details about the functions of each function module, refer to the corresponding embodiments, which are not described here.

It may be understandable that, the mode matching apparatus 700 in the embodiment may be set on the DPI devices, security protection devices, or other related devices, so as to support functions of the bandwidth management, content charging, and information security.

It can be seen from the above that, in the embodiment of the present invention, the mode matching apparatus 700 introduces at least one logical matching field that is used to match the logical matching relationship in the mode matching string that includes the character matching field, and matches the target character string using the mode matching string that includes the logical matching field, in which the matching is performed on the character substring at a corresponding position in the target character string by using the character matching field and the matching is performed on the logical relationship included in the target character string by using the logical matching field. Such mechanism enables the mode matching to support accurate retrieval and matching of text information that includes logical relationship information, which improves the capability of matching the text information that carries logical relationship information and extends applications of mode matching.

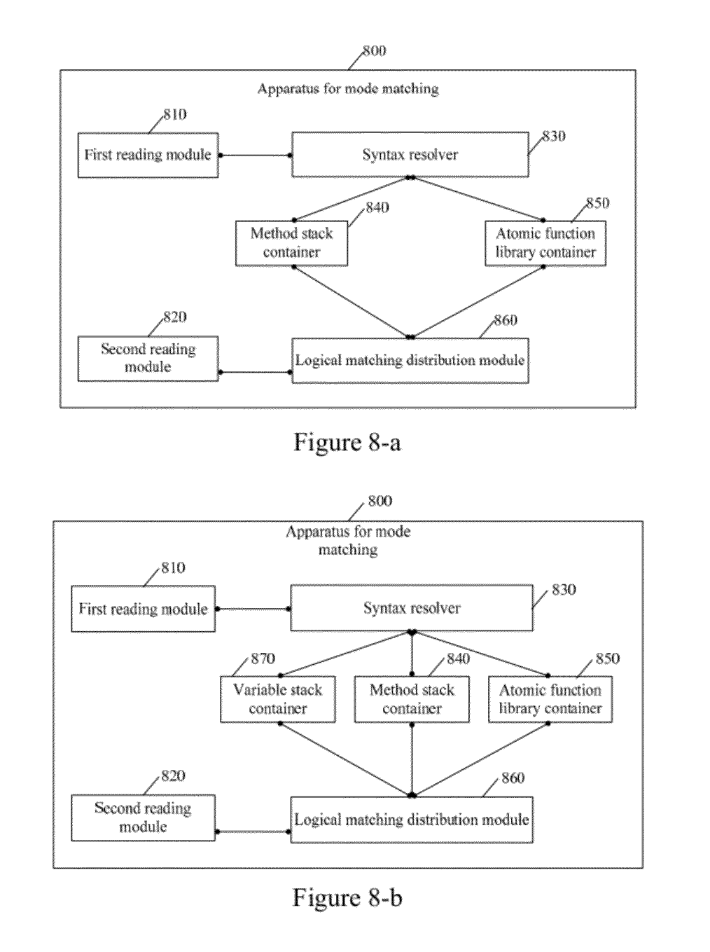

As shown in FIG. 8-a, a mode matching apparatus 800 provided by an embodiment of the present invention. A mode matching apparatus 800 includes a first reading module 810, a second reading module 820, a syntax resolver 830, a method stack container 840, an atomic function library container 850, and a logical matching distribution module 860.

The first reading module 810 is configured to read a mode matching string, where the mode matching string includes at least one logical matching field that is used to match a logical relationship.

In actual applications, the mode matching string that is read by the first reading module 810 may include at least one logical matching field that is used to match a logical relationship through a logical operation or other methods. Certainly, the mode matching string may further include at least one character matching field that is used to match a character string. The character matching field may be a regular expression or a character string (including one or more characters).

If the mode matching string read by the first reading module 810 includes a character matching field, and one or more character matching fields include a regular expression, the regular expression may be a PERL compatible regular expression (PCRE), a portable operating system interface of Unix (POSIX), or other types of regular expressions.

In actual applications, different types of matching fields may, for example, be set to different separators or formats. Therefore, it may be determined that each matching field in the mode matching string is a character matching field or a logical matching field according to the separators or formats. Specific symbols may be set in order to specify an area of a logical matching field. For example, an area of a logical matching field may begin at (?F and end at “)”. The area between “(?F” and “)” is an area of a logical matching field. Certainly, other specific symbols may be used to specify an area of a logical matching field, which are not restricted here.

The second reading module 820 is configured to read a target character string to be matched.

The second reading module 820 reads the target character string from received data packets (such as messages). The target character string to be matched may include a logical relationship. The logical relationship may be a logical relationship that needs to be satisfied between character substrings at two positions in the target character string to be matched or may be other logical relationship, which is not restricted here.

The syntax resolver 830 is configured to resolve syntax of a logical matching unit in the mode matching string read by the first reading module 810.

The method stack container 840 is configured to store an entry address of a function that corresponds to each logical matching field that is in the mode matching string and resolved by the syntax resolver 830; obtain the entry address of the function based on the name of the function that corresponds to the logical matching field resolved by the syntax resolver 830 and a mapping table related to he name of the function.

The atomic function library container 850 is configured to store a function invoking group includes the function (that is, the function that corresponds to each logical matching field in the mode matching string).

The logical matching distribution module 860 is configured to invoke, during a process of performing logical matching that corresponds to the logical matching field in the mode matching string, a corresponding function in the function invoking group stored by the atomic function library container 850 to perform matching on the logical relationship in the target character string to be matched read by the second reading module 820 according to the entry address of the function that corresponds to the logical matching field stored in the method stack container 840.

The logical relationship matched by the logical matching field may include a certain logical relationship which a certain character substring or multiple character substrings in the target character string need to satisfy.

As shown in FIG. 8-b, the mode matching apparatus 800 further includes:

a variable stack container 870, configured to store a variable introduced during a process of performing a logical operation that corresponds to the logical matching field in the mode matching string.

The modules of mode matching apparatus 800 work as follows:

After the first reading module 810 reads the mode matching string that includes at least one logical matching field that is used to match the logical relationship, the syntax resolver 830 resolves the syntax of the logical matching field in the mode matching string read by the first reading module 810; the method stack contain 840 stores the entry address of the function that corresponds to each logical matching field in the mode matching string resolved by the syntax resolver 830; the logical matching distribution module 860 invokes, during a process of performing logical matching that corresponds to the logical matching field in the mode matching string, a corresponding function in the function invoking group stored by the atomic function library container 850 to perform matching on the logical relationship in the target character string to be matched read by the second reading module 820 according to the entry address of the function that corresponds to the logical matching field stored in the method stack container 840. If a variable is introduced, the variable stack container 870 stores the variable.

It may be understandable that, the mode matching apparatus 800 is configured to implement part or all the technical solutions of the present invention. For details about the functions of each function module, refer to corresponding embodiments, which are not described here.

It may be understandable that, the mode matching apparatus 800 in the embodiment may be set on the DPI devices, security protection devices, or other related devices, so as to support functions of the bandwidth management, content charging, and information security.

It can be seen from the above that, the mode matching apparatus 800 in the embodiment introduces, in the mode matching string, at least one logical matching field that is used to match the logical matching relationship, introduces the syntax resolver that is configured to resolve the syntax of the logical matching field in the mode matching string, introduces the method stack container that is configured to store the entry address of the function that corresponds to each logical matching field in the mode matching string resolved by the syntax resolver, and introduces the atomic function library container that is configured to store a function invoking group. During a process of performing a logical matching operation that corresponds to the logical matching field in the mode matching string, a corresponding function in the function invoking group stored by the atomic function library container is invoked to perform matching on the logical relationship in the read target character string to be matched according to the entry address of the function that corresponds to the logical matching field stored in the method stack container. The implementation architecture is simple and flexible. The mode matching system based on the present architecture improves the capability of matching the text information that carries logical relationship information and extends applications of mode matching.

It should be noted that the method embodiments are described using a series of action combinations to simplify the description. Those skilled in the art must understand that the present invention is not restricted by the action sequence. According to the present invention, certain processes can be implemented in other sequence or simultaneously. Those skilled in the art must understand that the embodiments in the present document are exemplary embodiments. The related actions and modules are not definitely mandatory in the present invention.

The preceding embodiments pose different emphases on the descriptions. Certain embodiments do not provide detailed description. For details, refer to the description of other embodiments.

It can be seen from the above that, in a technical solution provided by the embodiments of the present invention, at least one logical matching field that is used to match the logical matching relationship by performing a logical operation is introduced in the mode matching string, and the target character string is matched by using the mode matching string that includes the logical matching field, and when the logical matching field in the mode matching string is used to perform matching, the matching is performed on the logical relationship included in the target character string by performing a logical operation that corresponds to the logical matching field. Such mechanism enables the mode matching to support accurate retrieval and matching of text information that includes logical relationship information, which improves the capability of matching the text information that carries logical relationship information and extends applications of mode matching.

It can be seen from the above that, in another technical solution provided by the embodiments of the present invention, at least one logical matching field that is used to match the logical matching relationship is introduced in the mode matching string that includes the character matching field, and the target character string is matched by using the mode matching string that includes the logical matching field, in which the matching is performed on the character substring at a corresponding position in the target character string by using the character matching field and the matching is performed on the logical relationship included in the target character string by using the logical matching field. Such mechanism enables the mode matching to support accurate retrieval and matching of text information that includes logical relationship information, which improves the capability of matching the text information that carries logical relationship information and extends applications of mode matching.

Further, the logical matching fields may be used to perform various logical matching and perform the retrieval and matching of variable feature character strings. If a mode matching string of a new protocol is added to a DPI device, the matching of a feature character string of the new protocol may be easily completed based on the previous mode matching process, and the seamless upgrade on function and service identifying of the DPI device is supported.

Those skilled in the art can understand that part or all steps in various methods used in the embodiments are complete by programs using the related instructions on the related hardware. The programs can be stored in the readable storage medium of a computer. The storage medium includes: read-only memory (ROM), random access memory (RAM), disk, or CD-ROM.

This document describes the method and apparatus for mode matching. This document describes the principles and implementation methods using examples. The embodiments are used to help those skilled in the art understand the methods and core principles. Based on the principles of the present invention, the specific implementation methods and application scope can be changed. The content in this document must not be understood as restricts on the present invention.

What is claimed is:

1. A method for mode matching, comprising:
reading a mode matching string, wherein the mode matching string comprises at least one logical matching field that is used to match a logical relationship;
reading a target character string to be matched, wherein the target character string to be matched comprises a logical relationship;
performing, by using the logical matching field in the mode matching string, logical matching on the logical relationship in the target character string to be matched.

2. The method of claim 1, wherein:
the performing, by using the logical matching field, the logical matching on the logical relationship in the target character string to be matched comprises:
performing, by performing a logical operation that corresponds to the logical matching field, the logical matching on the logical relationship in the target character string to be matched.

3. The method of claim 2, wherein:
the performing, by performing a logical operation that corresponds to the logical matching field, the logical matching on the logical relationship in the target character string to be matched comprises:
invoking a function that corresponds to the logical matching field; and
performing, by performing a logical operation that is described by the function, the logical matching on the logical relationship in the target character string to be matched, and returning a matching result.

4. The method of claim 2, wherein the logical operation that corresponds to the logical matching field comprises one of following operation or a combination of more following operations:
adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right.

5. The method of claim 1, wherein:
the mode matching string further comprises:
at least one character matching field that is used to match a character string, and the method further comprises:
performing, by using the character matching field in the mode matching string, character matching on the target character string to be matched, wherein the logical matching field and character matching field are used to match the target character string based on the sequence of the logical matching fields and character matching fields or the logical matching fields and character matching fields are concurrently used to match the target character string.

6. A method for mode matching, comprising:
reading a mode matching string, wherein the mode matching string comprises at least one logical matching field that is used to match a logical relationship and at least one character matching field that is used to match a character string;
reading a target character string to be matched, wherein the target character string to be matched comprises a logical relationship;
determining whether the character matching field or logical matching field in the mode matching string is currently used to perform matching;
if it is determined that the character matching field in the mode matching string is currently used to perform matching, triggering a character matching operation that corresponds to the character matching field to perform matching on a character substring at a corresponding position in the target character string to be matched; and
if it is determined that the logical matching field in the mode matching string is currently used to perform matching, triggering a logical matching operation that corresponds to the logical matching field to perform matching on the logical relationship in the target character string to be matched.

7. The method of claim 6, wherein:
the triggering a logical matching operation that corresponds to the logical matching field to perform matching on the logical relationship in the target character string to be matched comprises:
performing, by performing a logical operation that corresponds to the logical matching field, the matching on the logical relationship in the target character string to be matched.

8. The method of claim 7, wherein the logical operation that corresponds to the logical matching field comprises one of following operations or a combination of more following operations:
adding, subtracting, multiplying, dividing, equal to, not equal to, greater than, equal to or greater than, less than, less than or equal to, assignment, logical OR, logical AND, bitwise AND, bitwise OR, other than, negation, exclusive OR, shift left, and shift right.

9. The method of claim 6, wherein, the character matching field is a regular expression or a character string.

10. An apparatus for mode matching, comprising:
a first reading module, configured to read a mode matching string, wherein the mode matching string comprises at least one logical matching field that is used to match a logical relationship;
a second reading module, configured to read a target character string to be matched, wherein the target character string to be matched comprises a logical relationship; and
a logical matching module, configured to perform, by using the logical matching field, matching on the logical relationship in the target character string read by the second reading module.

11. The apparatus of claim 10, wherein the logical matching module is configured to perform, by performing a logical operation that corresponds to the logical matching field, the matching on the logical relationship in the target character string to be matched.

12. The apparatus of claim 10, wherein
the mode matching string read by the first reading module further comprises at least one character matching field that is used to match a character string, and the mode matching apparatus further comprises a character matching module;
the character matching module is configured to perform, by using the character matching field in the mode matching string, character matching on the target character string to be matched, wherein the matching on the target character string to be matched is performed according to a sequence of the logical matching fields and character matching fields in the mode matching string; or logical matching and character matching are concurrently performed by using the logical matching fields and character matching fields in the mode matching string to respectively perform the matching on the target character string to be matched.

13. The apparatus of claim 10, wherein the logical matching module comprises:
a syntax resolver, configured to resolve syntax of the logical matching field in the mode matching string read by the first reading module;
a method stack container, configured to store an entry address of a function that corresponds to each logical matching field that is in the mode matching string and resolved by the syntax resolver;
an atomic function library container, configured to store a function invoking group that includes the function; and
a logical matching distribution module, configured to invoke, during a process of performing logical matching that corresponds to the logical matching field in the mode matching string, a corresponding function in the function invoking group stored by the atomic function library container to perform matching on the logical relationship in the target character string to be matched read by the second reading module according to the entry address of the function that corresponds to the logical matching field stored in the method stack container.

14. The method of claim 13, further comprising:
a variable stack container, configured to store a variable introduced during a process of performing the logical operation that corresponds to the logical matching field in the mode matching string read by the first reading module.

15. An apparatus for mode matching, comprising:
a first reading module, configured to read a mode matching string, wherein the mode matching string comprises at least one logical matching field that is used to match a logical relationship and at least one character matching field that is used to match a character string;
a second reading module, configured to read a target character string to be matched, wherein the target character string to be matched comprises a logical relationship;
a type determining module, configured to determine whether the character matching field or logical matching field in the mode matching string is currently used to perform matching;
a character matching module, configured to: if the type determining module determines that the character matching field in the mode matching string is currently used to perform matching, then trigger a character matching operation that corresponds to the character matching field to perform matching on a character substring at a corresponding position in the target character string to be matched;
a logical matching module, configured to: if the type determining module determines that the logical matching field in the mode matching string is currently used to perform matching, then trigger a logical matching operation that corresponds to the logical matching field to perform matching on the logical relationship in the target character string to be matched.

16. The apparatus of claim 15, wherein a logical matching module is configured to: if the type determining module determines that the character matching field in the mode matching string is currently used to perform matching, then perform, a logical operation that corresponds to the logical matching field, the matching on the logical relationship in the target character string to be matched.

17. The apparatus of claim 15, wherein the logical matching module comprises:
the syntax resolver, configured to resolve syntax of a logical matching unit in the mode matching string read by the first reading module;
a method stack container, configured to store an entry address of a function that corresponds to each logical matching field that is in the mode matching string and resolved by the syntax resolver;
an atomic function library container, configured to store a function invoking group that includes the function; and
a logical matching distribution module, configured to invoke, during a process of performing logical matching that corresponds to the logical matching field in the mode matching string, a corresponding function in the function invoking group stored by the atomic function library container to perform matching on the logical relationship in the target character string to be matched read by the second reading module according to the entry address of the function that corresponds to the logical matching field stored in the method stack container.

18. The apparatus of claim 17, further comprising:
a variable stack container, configured to store a variable introduced during a process of performing the logical operation that corresponds to the logical matching field in the mode matching string read by the first reading module.
